(19) United States
(12) Patent Application Publication
(10) Pub. No.: US 2024/0208370 A1
(43) Pub. Date: Jun. 27, 2024

(54) ADJUSTMENT SYSTEM FOR THE VEHICLE INTERIOR WITH THE POSSIBILITY OF GENERATING A VISUAL INDICATION OF A POTENTIAL OBSTACLE

(71) Applicant: BROSE FAHRZEUGTEILE SE & CO. KOMMANDITGESELLSCHAFT, BAMBERG, Bamberg (DE)

(72) Inventors: Christian HERRMANN, Grossheirath (DE); Peter HORN, Kemmern (DE); Matthias GEMPEL, Bamberg (DE); Christopher TRENKLE, Bamberg (DE); Hans BAUER, Bamberg (DE); Jasmin PFEUFER, Schesslitz (DE); Timo WITZEL, Flieden (DE); Thomas WEINGÄRTNER, Lichteneiche (DE)

(21) Appl. No.: 18/555,452

(22) PCT Filed: Apr. 14, 2022
(86) PCT No.: PCT/EP2022/059991

§ 371 Date: Dec. 22, 2023

(30) Foreign Application Priority Data
Apr. 19, 2021 (DE) 10 2021 109 828.9

(51) Int. Cl. B60Q 3/76; B60N 2/005; B60N 2/02

(52) U.S. Cl. CPC B60Q 3/76; B60N 2/005; B60N 2/0278; B60N 2002/0055; B60N 2210/20; B60N 2210/24; B60Q 2400/20

(57) ABSTRACT

It is provided an adjustment system for a vehicle, comprising at least one electronic obstacle-detection device for detecting a potential obstacle in an adjustment path of the at least one interior component to be adjusted by an external force, wherein the at least one obstacle-detection device is configured to generate at least one obstacle signal on detection of a potential obstacle in the adjustment path, and control electronics which are configured to generate at least one control signal for outputting a visually perceptible obstacle indication for a user in response to the at least one obstacle signal, via which the potential obstacle is indicated.

### BACKGROUND

The proposed solution relates to an adjustment system for a vehicle.

Adjustment systems in the vehicle interior are widely known. Such adjustment systems comprise at least one adjusting device for the power-operated adjustment of at least one interior component to be arranged in an interior space of the vehicle, such as for example a vehicle seat, an armrest, a load-through, a headrest or a center console.

It is furthermore known to provide at least one electronic obstacle-detection device on a vehicle for detecting a potential obstacle in an adjustment path of an adjusting part to be adjusted by an external force. For example, different obstacle-detection devices are utilized in order to detect potential obstacles in the external environment of the vehicle on adjustment of a vehicle door and to avoid that the vehicle door adjusted by an external force collides with an obstacle.

### SUMMARY

It now is the object of the proposed solution to provide an improved adjustment system for the vehicle interior, which in particular offers a higher comfort and benefit for the vehicle user.

This object is achieved with an adjustment system as described herein.

Beside at least one adjusting device for the power-operated adjustment of at least one interior component to be arranged in an interior space of the vehicle, a proposed adjustment system comprises at least one electronic obstacle-detection device for the (possibly contactless, for example optical, radar-assisted or laser-assisted) detection of a potential obstacle in an adjustment path of the at least one interior component during a power-operated adjustment in the interior of the vehicle. The at least one obstacle-detection device is configured to generate at least one obstacle signal on detection of a potential obstacle in the adjustment path. Via control electronics of the adjustment system, at least one control signal is generated in response to the at least one obstacle signal for outputting a visually perceptible obstacle indication of the potential obstacle for a user.

In the proposed solution, the obstacle-detection device consequently not only is configured to stop an adjustment of an interior component, in particular to block the beginning of the adjustment triggered already or to slow down an already started adjusting movement until standstill, and/or to reverse an already started adjusting movement of the interior component, in order to avoid a collision of the interior object with the potential obstacle by the power-operated adjustment of the interior object. Rather, the obstacle-detection device is also coupled with control electronics that generate a visually perceptible indication for a user, in order to specifically indicate the presence of the potential obstacle to the user.

It can be provided for example that a corresponding visually perceptible obstacle indication is output on an indicating element provided therefor in the vehicle, such as for example on a display. Such a display then can be arranged for example on a dashboard or on or in a pane of the vehicle. For example, via a corresponding indication on a display on the window pane of a vehicle door on the driver's side of the vehicle, the presence of a potential obstacle, which is located in the adjustment path of a vehicle seat to be adjusted, is indicated to a user. In this way, not only a collision of an interior component to be adjusted in the vehicle interior is prevented, but a user also is specifically informed of whether and possibly where an obstacle is present in the adjustment path of the interior component, and hence why the adjusting movement desired by him/her possibly cannot be carried out or can at least not be carried out completely.

In one design variant it is provided that the visually perceptible obstacle indication
a. is output at an interior region of the interior space of the vehicle, in which the potential obstacle is present, and/or
b. is output at an object region of the interior object, on which the interior object would collide with the detected obstacle during an (occurring or further) adjustment along the adjustment path, and/or
c. is output on a mobile terminal of the user.

When the obstacle indication is output at the interior region, in which the potential obstacle is present, the potential obstacle for example or at least its environment is specifically illuminated or lit up, so that a user can recognize directly at which point the potential obstacle was detected. This makes it easier for the user to find and remove the potential obstacle.

A corresponding facilitation also involves an alternatively or additionally provided output of the obstacle indication at an object region of the interior object to be adjusted. For example, at least one illuminating element can be arranged on the interior object in order to specifically allow a region of the interior object to light up. Corresponding illuminating elements can be provided for example in a seat part, a backrest and/or a headrest of a vehicle seat, for example each in seams of a cover. Via the control signal, particular areas of the vehicle seat can then be illuminated specifically, in which there is a risk of collision with the obstacle when the vehicle seat is adjusted as desired by an external force. For example, during a desired rotation of a seat part in the direction of a vehicle long side, an illumination of an area on that seat long side can be provided via an illuminating element or a plurality of illuminating elements, which is/are facing this vehicle long side, when it is detected by means of sensors that a potential obstacle is present in the adjustment path of the vehicle seat.

When an obstacle indication is output on a mobile terminal of the user, the obstacle indication can be visualized for example on a virtual image of the vehicle interior, namely at a point at which a potential obstacle was detected via the obstacle-detection device. Here as well, a user not only is alerted via the output visual obstacle indication that a potential obstacle is present in the adjustment path of an interior object to be adjusted. Rather, the user also obtains an information of the point at which the potential obstacle was detected.

In one design variant, the at least one obstacle signal contains an information of the interior region (of several possible interior regions) and/or of the object region (of several possible object regions) at which the visually perceptible obstacle indication is to be output. The at least one electronic obstacle-detection device of the control electronics for example can provide an information as to which of possibly several currently adjustable interior objects is prevented from being adjusted further due to a potential obstacle, and where this potential obstacle is located in the vehicle interior. In one design variant, the adjustment system consequently can be adapted and provided for the adjustment of at least two different interior objects, for example for the adjustment of at least two different vehicle seats and/or for the adjustment in connection with an adjustment scenario including several adjusting movements of different interior components. The obstacle-detection device then can be configured to vary the at least one obstacle signal in dependence on the interior object for which the potential obstacle was detected. It thus is communicated to the control electronics via the at least one obstacle signal which interior object is prevented from being adjusted due to a potential obstacle. In this way, the control electronics then can output an obstacle indication appropriate for the respective interior object.

In principle, the control electronics can be configured to vary the at least one visually perceptible obstacle indication in dependence on the interior region and/or object region in which the potential obstacle was detected. For example, as already explained above, different illuminating elements can be actuated in dependence on where the potential obstacle was detected.

Alternatively or additionally, the control electronics in one design variant is configured to vary the at least one visually perceptible obstacle indication in dependence on the kind and/or the size of the detected potential obstacle. For example, the obstacle indication can be different when an object or a person was detected in the adjustment path via the at least one obstacle-detection device. As in the case of a person present in the adjustment path quite a considerable risk of injury possibly exists, the obstacle indication can here be output with a higher intensity and possibly also be accompanied by an acoustic warning signal. Higher intensity of the obstacle indication for example means that an output via at least one illuminating element is signaled with a different, for example more vivid color, increased brightness and/or by flashing. For differentiating a kind of obstacle, the electronic obstacle-detection device can implement a classification logic in which different object classes for potential obstacles are taught-in, so that the obstacle-detection device can differentiate for example between a person, then possibly also between an adult and a child, and an object.

In principle, the control electronics can be configured to generate the control signal for actuating at least one illuminating element, via which the visually perceptible obstacle indication is output. Such an illuminating element then is arranged in the interior of the vehicle or at the interior component to be adjusted. The control electronics furthermore can then be configured to vary the control signal in dependence on the at least one obstacle signal in order to actuate the at least one illuminating element for outputting the visually perceptible obstacle indication for different time periods, in different colors and/or with different brightnesses. For example, the illuminating element can shine continuously when an object is detected as a potential obstacle, and flash when a person is detected as a potential obstacle. Depending on the size, position or interior object to be adjusted, the illuminating element can also be actuated in different colors and/or with different brightnesses, in order to indicate the potential obstacle to the user in a targeted way.

In one design variant, the control electronics furthermore are configured to generate at least one positioning signal for actuating at least one indication element via which a visually perceptible positioning indication is output at an interior region of the interior of the vehicle and/or at an object region on the interior object to be adjusted or on another interior object, which is located outside the adjustment path of the interior object to be adjusted. Via the visually perceptible positioning indication a user is informed of a possible position of the detected obstacle, with which the disturbance would be eliminated on adjustment of the interior object to be adjusted. With the positioning indication an alternative position of the detected obstacle consequently is visually proposed to the user, in which there is no more risk of collision with the interior object to be adjusted. For example, several illuminating elements can be actuatable by the control electronics so as to provide a visual proposal for a user as to how the collision event triggered with the detected potential obstacle can be eliminated. When the obstacle for example is detected in a foot space of a vehicle seat to be adjusted, the obstacle—for outputting the obstacle indication—is illuminated in red via an illuminating element on the side of the vehicle interior and/or the foot space is illuminated in read via floor-side illuminating elements and/or an adjacent seat part area of the vehicle seat is illuminated in red. In addition, a positioning indication is output by illuminating the seating surface of an adjacent vehicle seat in green or by seat seams of the seat part of this adjacent vehicle seat shining in green. It thereby is indicated to a user that on deposition of the detected object at this point-based on the adjustment scenario chosen last or the desired adjustment of the vehicle seat to be adjusted—there is no risk of collision.

In principle, the control electronics can be configured to vary a corresponding positioning signal in dependence on the obstacle signal. What position is proposed via a positioning indication as a possible option for the new positioning of the detected obstacle by means of the control electronics then for example depends on the question at what point and/or for what interior object, in particular for which of several possible adjustment scenarios (in which several interior objects are adjusted at the same time or one after the other) a potential obstacle is detected, whether the detected obstacle is a person or an item and/or how large the detected obstacle is. Correspondingly, the control electronics in particular can be configured to vary the positioning signal in dependence on the kind and/or the size of the detected potential obstacle.

To also inform the user of when a possible case of collision has been eliminated, the control electronics in one design variant are configured to terminate the output of the visually perceptible obstacle indication when it is detected via the obstacle-detection device that the potential obstacle no longer is present in the adjustment path of the interior object. A corresponding illumination or display consequently goes out when the obstacle has been removed from the adjustment path and the triggered adjusting movement of the interior object can be effected or continued.

In principle, the obstacle-detection device can be provided for the contactless monitoring in a vehicle interior and therefor include for example a camera, in particular a time-of-flight camera (ToF camera). The obstacle-detection device furthermore can also include for example at least one radar sensor and/or at least one lidar sensor.

The proposed solution furthermore comprises a vehicle with a design variant of a proposed adjustment system.

The attached FIGURE by way of example illustrates possible design variants of the proposed solution.

### BRIEF DESCRIPTION OF THE DRAWINGS

In the drawing:

FIG. 1 shows a top view of a vehicle interior with a design variant of a proposed adjustment system, which here in particular is provided for the adjustment of several interior components in the form of vehicle seats.

### DETAILED DESCRIPTION

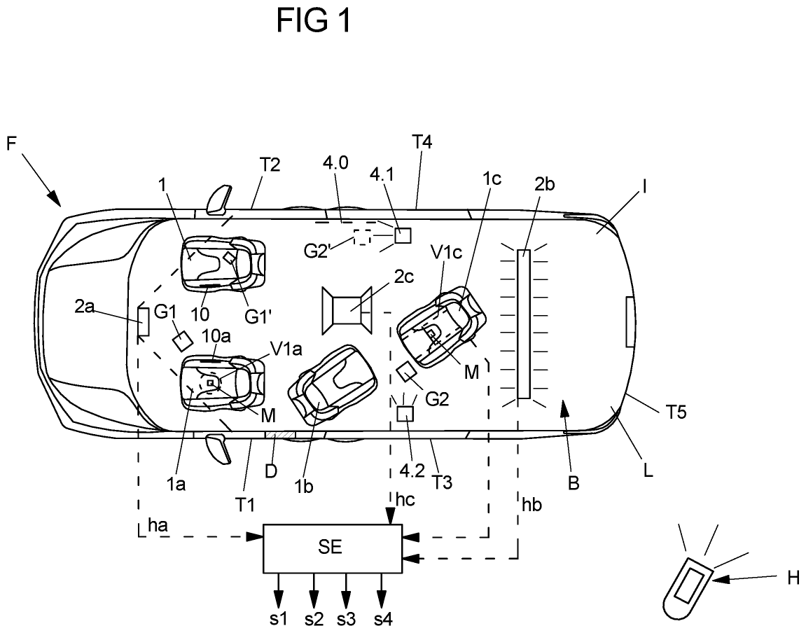

FIG. 1 shows a top view of a vehicle F with an interior I, on whose vehicle floor B and in particular in a loading space L interior components adjustable by an external force can be arranged. FIG. 1 by way of example shows four adjustable vehicle seats 1, 1a, 1b and 1c as such interior components. The vehicle seats 1, 1a, 1b and 1c can be adjusted in different ways by motor support via the respectively associated adjusting devices, shown by way of example for the vehicle seats 1a and 1c in the form of adjusting devices V1a and V1c. This for example includes a rotation of a vehicle seat 1, 1a, 1b or 1c about a vertical vehicle axis, tilting into a reclined position and a longitudinal displacement along the vehicle floor B.

To prevent that a vehicle seat 1, 1a, 1b or 1c to be adjusted collides with a person or an item during a desired adjustment, the vehicle interior I is monitored via a plurality of obstacle-detection devices 2a, 2b and 2c. The obstacle-detection devices 2a, 2b and 2c operate in a contactless way and for example comprise at least one camera, in particular a ToF camera, a radar sensor and/or a lidar sensor. When one of the obstacle-detection devices 2a, 2b or 2c is used to detect a potential obstacle in an adjustment path of a vehicle seat 1, 1a, 1b or 1c to be adjusted, the corresponding adjusting movement is inhibited, stopped and/or reversed in order to avoid a collision of the vehicle seat 1, 1a, 1b or 1c with the respective obstacle.

To indicate a related collision event to a user of the vehicle F in this connection and in particular to instruct the user to remove the potential obstacle and possibly also inform him/her of how to remove the obstacle, each obstacle-detection device 2a, 2b and 2c in the present case is coupled with control electronics SE, which are configured to output an obstacle indication visually perceptible for the user, when a potential obstacle is detected in an adjustment path of a vehicle seat 1, 1a, 1b or 1c to be adjusted.

In FIG. 1 it is for example illustrated by way of example that the vehicle seat 1a on a driver's side of the vehicle seat F, the driver's seat, is to be rotated in the direction of the adjacent vehicle seat 1, the passenger seat, via an adjusting device V1a including at least one adjusting motor M. In the adjustment path defined therewith in the direction of the passenger seat 1, however, a potential obstacle G1 in the form of an item is present on the vehicle floor B. This obstacle G1 is detected by both obstacle-detection devices 2a and 2c, which in response thereto provide obstacle signals ha, hc to the control electronics SE. In response to these obstacle signals ha and hc the adjusting movement of the vehicle seat 1a is inhibited on the one hand. At the same time, the control electronics S generate different control signals s1, s2, s3 via which the obstacle G1 in risk of collision in the adjustment path of the vehicle seat 1a is indicated to a user.

Via the control signals s1, s2, s3 an illuminating element 10a in the seat part of the vehicle seat 1a for example is actuated for this purpose. This illuminating element 10a is provided in a side bolster of the seat part of the vehicle seat 1a facing the passenger seat 1 and then lights up in red. In this way, a region at which the vehicle seat 1a would collide with the obstacle G1 during the planned adjustment is signaled to a user at the vehicle seat 1a. In addition, the control electronics SE can actuate an illuminating element at the roof liner in order to illuminate the obstacle G1. In this connection it can be provided, for example, that via the illuminating element a light cone is specifically directed to the detected obstacle G1.

To additionally point out to the user how the obstacle G1 can be removed, so that the desired adjustment of the driver's seat 1a can be effected, a positioning signal s4 is also generated via the control electronics SE. Via this positioning signal s4 an illuminating element 10 then for example is actuated at the (unoccupied) passenger seat 1. The illuminating element 10 provided for example at the seat part of the passenger seat 1 lights up in green in response to the positioning signal s4 and thus signals to the user a possible alternative position G1′ for the item G1 on the passenger seat 1, in which the item G1 no longer would impede the adjustment of the driver's seat 1a.

By way of example, FIG. 1 furthermore shows how during an envisaged longitudinal adjustment of a vehicle seat 1c of a rear seat row an obstacle G2 is detected by the electronic obstacle-detection devices 2b and 2c and in response thereto obstacle signals hb and hc are transmitted to the control electronics SE. Thus, the adjustment of the vehicle seat 1c via its adjusting device V1c likewise equipped with at least one adjusting motor M here is also initially stopped or inhibited. In addition, the control electronics SE for example control the activation of an illuminating element 4.2 on the side of the vehicle interior via the control signals s1, s2, s3. This illuminating element 4.2 illuminates the detected obstacle G2. For example, the illuminating element 4.2 is located on the roof liner or on a B-pillar of the vehicle F.

At the same time, a floor-side illuminating element 4.0 and/or an illuminating element 4.1 on the side of the vehicle interior (e.g. on the roof liner or on an opposite B-pillar of the vehicle F) are actuated via a positioning signal s4. The illuminating element 4.0 on the vehicle floor B for example includes lightbars. Via one or both illuminating elements 4.0, 4.1 it is signaled by correspondingly illuminating or lighting a region on the vehicle floor B at which alternative position G2′ the obstacle G2 can be positioned, without then having the risk of a collision with the vehicle seat 1c to be adjusted during the desired adjustment.

In principle, the control electronics SE can be configured to communicate in a way visually perceptible for a user by means of illuminating elements in the vehicle interior I via corresponding control signals s1 to s4 whether and at which point an obstacle blocks a possible adjustment of an interior object, for example of a vehicle seat 1, 1a, 1b or 1c. For example, illuminating elements therefor can shine, e.g. flash, for different amounts of time and/or shine in different colors or color combinations and/or with different brightnesses. Analogously, the control electronics SE also can indicate to a user, as explained, at which point in the vehicle interior I and in particular on the vehicle floor B, the loading space L, at the interior object to be adjusted and/or at another interior object a potential obstacle can lay down in order to eliminate the detected collision event.

In the present case, it furthermore is provided that the output of an obstacle indication and of a positioning indication is automatically terminated when a removal of the respective obstacle, for example of the obstacle G1 or G2, from the adjustment path is detected via the electronic obstacle-detection device 2a, 2b or 2c.

Alternatively or additionally, the control electronics SE can also be configured to output corresponding obstacle indications and/or positioning indications on a mobile terminal H or on a vehicle-mounted display. Corresponding indications can be wirelessly transmittable from the control electronics SE to the mobile terminal, e.g. a mobile radio telephone. The mobile terminal here can also be provided to trigger and control an adjustment of a vehicle seat 1, 1a, 1b or 1c. A display D for outputting an obstacle indication and/or a positioning indication can be provided for example on the dashboard of the vehicle F or on one of several vehicle doors T1 to T5 of the vehicle F.

### LIST OF REFERENCE NUMERALS

1, 1a, 1b, 1c vehicle seat
10, 10a illuminating element/indicating element
2a, 2b, 2c obstacle-detection device
4.0, 4.1, 4.2 illuminating element/indicating element
B vehicle floor
D display (indicating element)
F vehicle
G1, G2 item/obstacle
G1′, G2′ alternative position
ha, hb, hc obstacle signal
H mobile terminal
I vehicle interior
L loading space
M adjusting motor
s1-s3 control signal
s4 positioning signal
SE control device
T1-T4 vehicle door
T5 liftgate (rear-side vehicle door)
V1a, V1c adjusting device

1. An adjustment system for a vehicle, comprising
at least one adjusting device for the power-operated adjustment of at least one interior component to be arranged in the interior of the vehicle,
at least one electronic obstacle-detection device for detecting a potential obstacle in an adjustment path of the at least one interior component during a power-operated adjustment of the at least one interior component in the interior of the vehicle, wherein the at least one obstacle-detection device is configured to generate at least one obstacle signal on detection of a potential obstacle in the adjustment path, and
control electronics, which are configured to generate at least one control signal in response to the at least one obstacle signal for outputting a visually perceptible obstacle indication of the potential obstacle for a user.

2. The adjustment system according to claim 1, wherein the visually perceptible obstacle indication is output at least one of
a. at an interior region of the interior of the vehicle, in which the potential obstacle is present,
b. at an object region of the interior object, on which the interior object would collide with the potential obstacle during an adjustment along the adjustment path, and
c. on a mobile terminal of the user.

3. The adjustment system according to claim 2, wherein the at least one obstacle signal contains information about at which of at least one of interior region and object region the visually perceptible indication is to be output.

4. The adjustment system according to claim 2, wherein the control electronics are configured to vary the at least one visually perceptible obstacle indication in dependence on at least one of the interior region and the object region in which the potential obstacle was detected.

5. The adjustment system according to claim 1, wherein the control electronics are configured to vary the at least one visually perceptible obstacle indication in dependence on at least one of the kind and the size of the detected potential obstacle.

6. The adjustment system according to claim 1, wherein the adjustment system is adapted and provided for the adjustment of at least two different interior objects, and the obstacle-detection device is configured to vary the at least one obstacle signal in dependence on the interior object for which the potential obstacle was detected.

7. The adjustment system according to claim 4, wherein the control electronics are configured to generate the control signal for actuating at least one illuminating element via which the visually perceptible obstacle indication is output, and to vary the same in dependence on the at least one obstacle signal in order to actuate the at least one illuminating element for outputting the visually perceptible obstacle indication at least one of for different time periods, in different colors and with different brightnesses.

8. The adjustment system according to claim 1, wherein the control electronics are configured to generate at least one positioning signal for actuating at least one indication element via which a visually perceptible positioning indication is output at least one of at an interior region of the interior of the vehicle and at an object region on the interior object to be adjusted or on another interior object, which is located outside the adjustment path of the interior object to be adjusted.

9. The adjustment system according to claim 7, wherein the control electronics are configured to vary the positioning signal in dependence on the obstacle signal.

10. The adjustment system according to claim 8, wherein the control electronics are configured to vary the positioning signal in dependence on at least one of the kind and the size of the detected potential obstacle.

11. The adjustment system according to claim 1, wherein the control electronics are configured to terminate the output of the visually perceptible obstacle indication when it is detected via the obstacle-detection device that the potential obstacle no longer is present in the adjustment path of the interior object.

12. The adjustment system according to claim 1, wherein the obstacle-detection device comprises at least one of at least one camera, at least one radar sensor and at least one lidar sensor.

13. A vehicle with an adjustment system according to claim 1.

14. The adjustment system according to claim 5, wherein the control electronics are configured to generate the control signal for actuating at least one illuminating element via which the visually perceptible obstacle indication is output, and to vary the same in dependence on the at least one obstacle signal in order to actuate the at least one illuminating element for outputting the visually perceptible obstacle indication at least one of for different time periods, in different colors and with different brightnesses.

15. The adjustment system according to claim 14, the control electronics are configured to vary the positioning signal in dependence on the obstacle signal.

16. The adjustment system according to claim 6, wherein the control electronics are configured to generate the control signal for actuating at least one illuminating element via which the visually perceptible obstacle indication is output, and to vary the same in dependence on the at least one obstacle signal in order to actuate the at least one illuminating element for outputting the visually perceptible obstacle indication at least one of for different time periods, in different colors and with different brightnesses.

17. The adjustment system according to claim 16, the control electronics are configured to vary the positioning signal in dependence on the obstacle signal.
